(19) United States
(12) Patent Application Publication
(10) Pub. No.: US 2013/0318475 A1
(43) Pub. Date: Nov. 28, 2013

(54) UNLOCKING METHOD FOR A TOUCH SCREEN

(71) Applicants: INVENTEC APPLIANCES (PUDONG) CORPORATION, Shanghai (CN); INVENTEC APPLIANCES CORP., Taipei (TW); INVENTEC APPLIANCES (NANCHANG) CORPORATION, Jiangxi (CN); INVENTEC APPLIANCES (SHANGHAI) CO., LTD., Shanghai City (CN)

(72) Inventor: Jian Xie, Shanghai (CN)

(73) Assignees: INVENTEC APPLIANCES (PUDONG) CORPORATION, Shanghai (CN); INVENTEC APPLIANCES (SHANGHAI) CO. LTD., Shanghai City (CN); INVENTEC APPLIANCES (NANCHANG) CORPORATION, Jiangxi (CN); INVENTEC APPLIANCES CORP., Taipei (TW)

(21) Appl. No.: 13/846,013

(22) Filed: Mar. 18, 2013

(30) Foreign Application Priority Data
May 25, 2012 (CN) 201210189977.3

(51) Int. Cl. G06F 3/0482

(52) U.S. Cl. CPC G06F 3/0482
USPC 715/823

(57) ABSTRACT

A method for unlocking a touch screen is applicable to an electronic device having a touch screen. The method includes displaying a main object on the touch screen upon the touch screen being locked; displaying a plurality of secondary objects in an arrangement on the touch screen upon a physical object touching the main object; highlighting the main object or one of the secondary objects when the touching has lasted for a first period; de-highlighting the highlighted and highlighting the main object or another of the secondary objects on the touch screen, when the touching has lasted for a second period longer than the first period; and upon the physical object leaving the touch screen when the main object or a secondary object is highlighted, unlocking the touch screen. And then a step of activating an application corresponding to the highlighted object may be performed.

### CROSS-REFERENCE TO RELATED APPLICATIONS

This non-provisional application claims priority under 35 U.S.C. §119(a) on Patent Application No(s). 201210189977.3 filed in China, P.R.C. on May 25, 2012, the entire contents of which are hereby incorporated by reference.

### BACKGROUND OF THE INVENTION

1. Field of the Invention

The present invention generally relates to an unlocking method for a touch screen, and more particularly to an unlocking method that can be performed to unlock the touch screen depending on the duration of a physical object's touching a position of a main object displayed on the touch screen, and to substantially simultaneously activate a particular application.

2. Description of the Prior Art

With the great progress of the various types of hardware and software technologies, electronic devices with various features have come out, whether in school, work or recreational level, all kinds of electronic devices and the habits of people gradually produce more and more closely connections, and brought a lot of convenience to people's lives. As more and more activities need to rely on different kinds of electronic devices to complete, therefore, manufacturers are all toward slim volume for the design and manufacture of a variety of electronic devices to bring users more convenient for portable electronic devices, but can use the various functions provided by such electronic devices. In recent years, a variety of portable electronic devices continue to emerge, such as personal digital assistants (Personal Digital Assistant; PDA), smart phone, Tablet PC, etc., not only functions are increasingly strengthen, but also convenience of carry-on is increased dramatically.

To interact with users and conventional electronic devices, conventional electronic devices will set many buttons for users to input information. Besides, such electronic devices also have display screens, in order to let users read on the display screen. The functions of the electronic devices are increasingly strengthened, and the range of applications is becoming more wider. Hence the electronic devices are inextricably linked with people's lives in a variety of activities, and the amount of information exchanged through the electronic devices is dramatically increased. Therefore, for huge amount of exchanged information, the dimensions of the display screen should be improved, and, if only to enhance the dimensions of the display screen, it will cause a rise in overall volume, but brings a negative impact to portability. A touch screen, having integration of the technical characteristics of input and output information, can be easier to obtain a good balance in demands of exchanging information and portability. Hence, touch screens gradually become mainstream equipment of the portable electronic device.

To avoid carelessly activating specific functions, such as telephone communication, etc., while user is carrying the electronic device, the electric device will install a screen-locking program in order to limit the touch screen executing operations. Hence, upon the touch screen being touched inadvertently, the specific functions of the electronic device being accidentally activated can be avoided. When the user wants to use the functions provided by the electronic device, a certain unlocking operation must be executed to deactivate the screen-locking program, in order to further operate the electronic device through the touch screen. So far, many vendors had developed unlocking methods for touch screens, but the known unlocking methods are only able to deactivate the screen-locking program, but cannot enable unlocking the screen while activating the applications in the electronic device. Although some manufacturers have developed an unlocking method that can simultaneously unlock the screen and activate specific applications, the activation is more complex. Hence, users have to specifically memorize different activation ways for different applications, and the pre-set function also lacks flexibility, and the unlocking method can not be initiated according to the habits of different users and different applications, so it is difficult to meet the needs of different users.

So, how to design an unlocking method for a touch screen to use the most simple and direct way to deactivate the screen-locking program, and to simultaneously activate the applications in the electronic device, and to easily adjust the activation ways of the applications depending on individuals' demands are the most important issue for skilled people in the art.

### SUMMARY OF THE INVENTION

Known methods for unlocking a touch screen still have foregoing many shortcomings, it is difficult to meet the needs of different users, thus the inventor is in a long-term observation according to users' demands and based on years of experiences in related industries, and finally worked out an unlocking method for touch screen of the present invention. Through the method of the present invention, user can unlock the screen in the most simple and direct way, and can rely on their individual needs to unlock and simultaneously activate applications in the electronic device.

An object of the present invention is to provide a method for unlocking a touch screen, applicable to an electronic device that has a touch screen. The method includes displaying a main object on the touch screen, upon the touch screen being locked; displaying a plurality of secondary objects in an arrangement on the touch screen upon a physical object touching a position on the touch screen corresponding to the main object; highlighting one of the main object or at least one of the secondary objects on the touch screen when the physical object's touch on the position has lasted for a first period; de-highlighting the main object or said at least one of the secondary objects on the touch screen and highlighting the main object or another of the secondary objects on the touch screen, when the physical object's touch on the position has lasted for a second period, wherein the second period is longer than the first period; and upon the physical object leaving the position on the touch screen when a secondary object of the secondary objects is highlighted, unlocking the touch screen and activating an application corresponding to the secondary object. Alternatively, a step of unlocking the touch screen may be performed upon the physical object leaving the position on the touch screen when the main object or a secondary object of the secondary objects is highlighted.

Hence, an operator can easily perform the method for unlocking a touch screen by using a physical object to touch a position on the touch screen corresponding to the main object. And during the unlocking method simply changing the duration of the physical object's touching on the touch screen can cause unlocking the touch screen and activating different applications corresponding to the highlighted objects. Therefore, the convenience is highly promoted.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by reading the accompanying drawings and the detailed description, wherein:

FIG. 1 illustrates a schematic view of mutual relations of main components applied to the electronic device of the present invention;

FIG. 2 illustrates a schematic view of applications stored in the electronic device of the present invention;

FIG. 3A illustrates a flow chart of a former stage in the unlocking method according to the present invention;

FIG. 3B illustrates a flow chart of a latter stage in the unlocking method according to the present invention;

FIG. 4 illustrates screens respectively displayed on the electronic device corresponding to a former stage in the unlocking method according to the present invention; and

FIG. 5 illustrates screens respectively displayed on the electronic device corresponding to a latter stage in the unlocking method according to the present invention.

### DETAILED DESCRIPTION OF THE INVENTION

Following preferred embodiments and figures will be described in detail so as to achieve aforesaid objects.

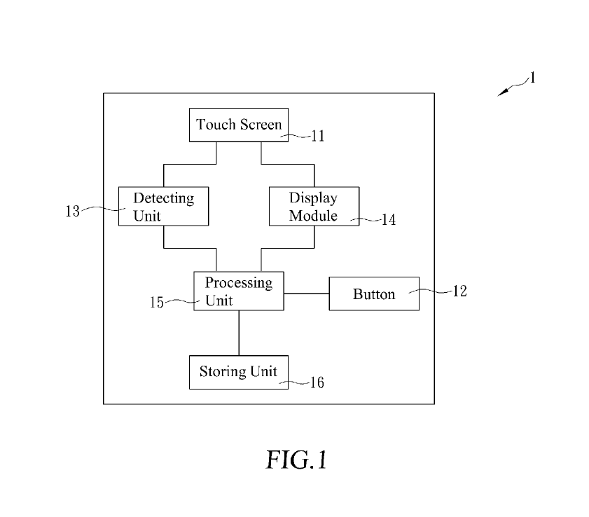

The present invention provides a method for unlocking touch screen, and the method is applicable to an electronic device as mobile phone or PDA. Please refer to FIG. 1, the electronic device 1 has a touch screen 11, a detecting unit 13, a display module 14, a processing unit 15, a storing unit 16, and at least one button 12, wherein the detecting unit 13, the touch screen 11 and the processing unit 15 are electrically connected with each other. Upon a physical object such as a finger or touch pen, not shown in figure, touching the touch screen 11, the detecting unit 13 may send a touch signal to the processing unit 15 according to an action activated by the physical object, the display module 14, the touch screen 11 and the processing unit 15 are electrically connected with each other, the display module 14 accepts instructions from the processing unit 15 and displays videos on the touch screen 11, the storing unit 16 may be a hard disk, memory or any other device able to store digital information and electrically connects with the processing unit 15, so that the storing unit 16 is capable of receiving instructions from the processing unit 15 for the processing unit 15 employs and stores the programs in the storing unit 16. The button 12 exposes on the surface of the electronic device 1 for operators' outside operations, and the button 12 electrically connects with the processing unit 15, hence the button 12 sends a pressing signal to the processing unit 15 upon an operator pressing the button 12.

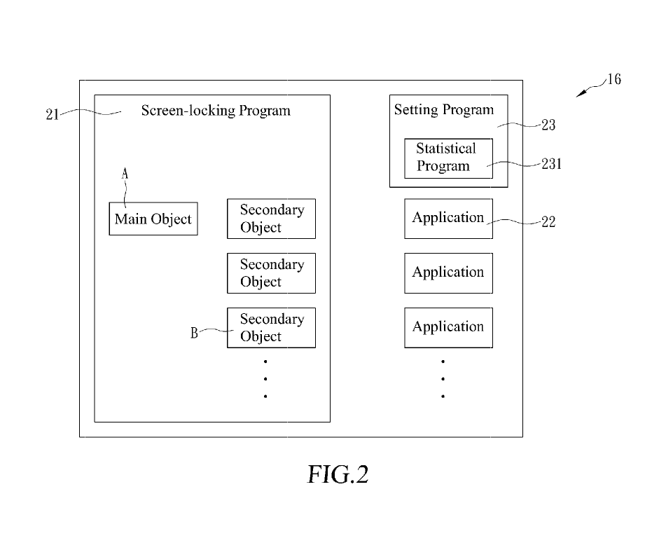

Please refer to FIG. 2, the storing unit 16 stores at least one screen-locking program 21, a plurality of applications 22 and a setting program 23. For the screen-locking program 21, the accepted touch operations of the touch screen 11, as shown in FIG. 1, will be limited while the screen-locking program 21 is being executed.

Therefore, operator is only able to execute a predetermined operation through the touch screen 11, and deactivate the screen-locking program 21. After that, other touch operations can then be executed through the touch screen 11. Again, with reference to FIG. 1 and FIG. 2, for saving the power of the electronic device 1, the electronic device 1 is under a power-saving mode while the electronic device is not being used, and the touch screen 11 is completely shut down, so that the touch screen 11 will not accept any touch operation or display any output video information. When an operator wants to operate the electronic device 1, the button 12 of the electronic device 1 is pressed in order to send a pressing signal to the processing unit 15. Consequently, the processing unit 15 activates the touch screen 11 and executes the screen-locking program 21; if the operator deactivates the screen-locking program 21 through a predetermined operation, other touch operations can then be operated by using the touch screen 11, ex. making phone calls, sending e-mails, etc. of the electronic device. In case of the operator having no further operations, the processing unit 15 may turn off the touch screen 11 and the screen-locking program 21 after a period of time in order to let the electronic device 1 be under the power-saving mode again. In practice, the screen-locking program 21 is not only being executed while the electronic device 1 is under or not under the power-saving mode, but also being executed while the electronic device 1 executes other operations. For instance, the screen-locking program 21 is executed while the operator watches a movie through the electronic device 1, so that a condition of carelessly touching the touch screen 11 to cause malfunction can be avoided. Meanwhile, if the operator is willing to deactivate the screen-locking program 21, pressing the button 12 to send a pressing signal to the processing unit 15 may use the electronic device to control the method for unlocking the touch screen for deactivating the screen-locking program 21, therefore the operator can operate the functions, such as adjusting the time-axis of a video playing software, expected by himself through the touching operations to the electronic device 1. Besides, the electronic device 1 not only executes the method of the present invention upon the operator pressing the button 12, but sends signals to the processing unit 5 or simultaneously executes the method while the electronic device 1 is under the power-saving mode for a period of time and the processing unit 15 automatically activates the screen-locking program 21 through other functions as gravity sensor, etc. The method of the present invention may be invoked by the manner in which is not the focus where desired protection of the present invention, the core spirit of the present invention performs the flow of the unlock method for the electronic device 1.

With reference to FIG. 1 and FIG. 2 again, for the unlock method of the present invention, the screen-locking program 21 has a plurality of secondary object B and at least one main object A. When the operator wants to deactivate the screen-locking program 21, the screen-locking program 21 may arrange the main object A or the plurality of secondary objects B on the touch screen 11 depending on the setup time and sequence in the electronic device 1 via the button 12 and other operations of the electronic device 1. As mentioned above, the storing unit 16 has a plurality of applications corresponding to the secondary objects B. For the embodiment, the storing unit 16 further stores a setting program 23, which is included in the screen-locking program 21 and could be independent for operations. The setting program 23 is able to adjust the setting values of the screen-locking programs 21 in order to change the time and sequence of the main object A and the secondary objects B displayed on the touch screen 11. The setting program 23 further has a statistical program 231 so as to gather and compile the times of the applications 22. Based on the times of the applications 22, the setting program 23 is able to adjust the setting values of the screen-locking program 21.

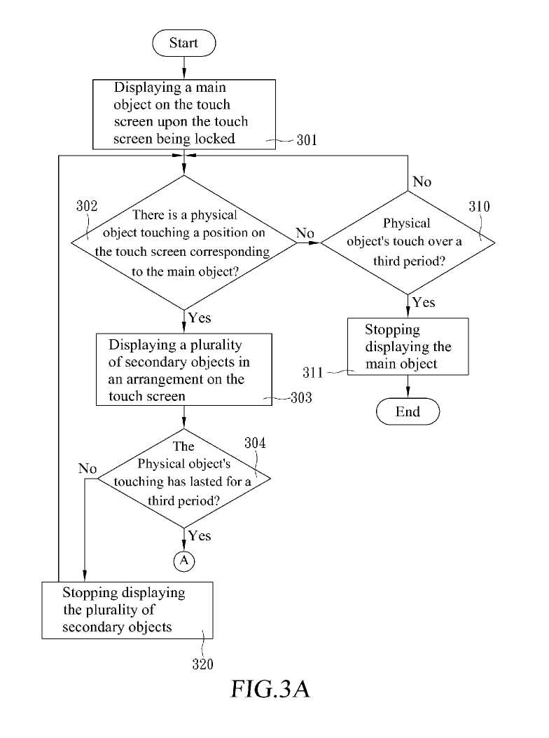

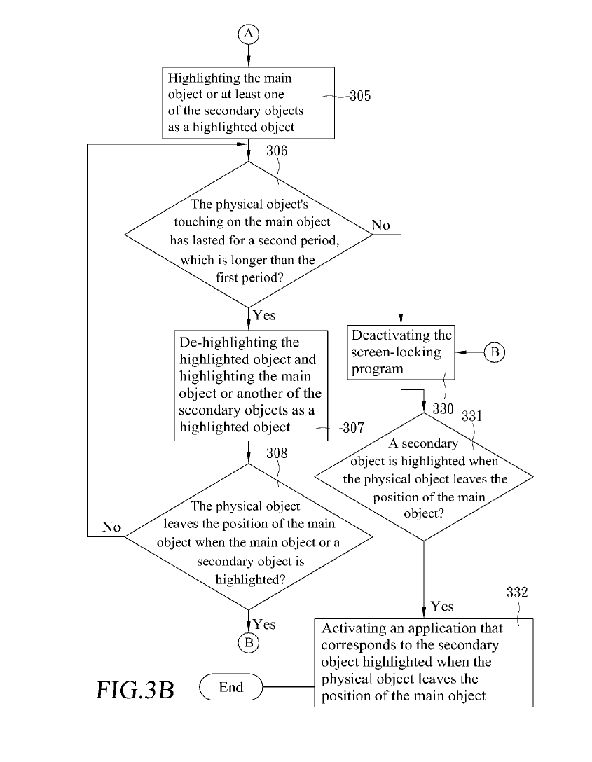

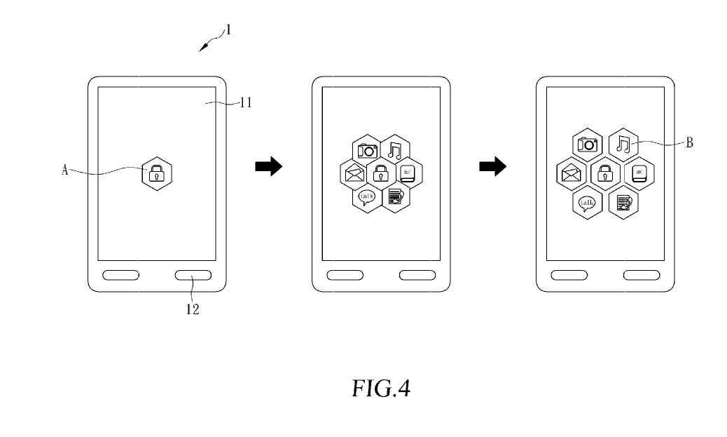

In addition, the present invention provides a method for unlocking touch screen. The entire flow for the method executed by the electronic device 1 may be divided into a former stage and a latter stage. The electronic device 1 can determine whether to deactivate the screen-locking program 21 in the former stage, and the electronic device 1 can determine whether to deactivate the screen-locking program 21 and substantially simultaneously execute the applications 22 in the latter stage. For describing the present invention in detail, the electronic device 1 executing the method for unlocking touch screen is described as follows. FIG. 3A and FIG. 3B respectively illustrate a flow chart of the former stage in the method according to the present invention and a flow chart of the latter stage in the method according to the present invention. As shown in FIG. 3A and FIG. 4, a former stage in the unlocking method in an embodiment of the present invention may include the steps of:

(301) displaying a main object on the touch screen 11 upon the touch screen being locked;

(302) determining whether there is a physical object touching a position on the touch screen corresponding to the main object; if yes, proceeding to step (303), otherwise, proceeding to step (310);

(303) displaying a plurality of secondary objects B in an arrangement on the touch screen 11;

(304) determining whether the physical object's touching on the main object has lasted for a first period; if yes, proceeding to step (305) as shown in FIG. 3B; otherwise, proceeding to step (320);

(310) determining whether the physical object's touching has lasted for a third period; if yes, proceeding to step (311), otherwise, proceeding to step (302); it's noted that the name “third period” is used merely to mean a separate period from the first period and the second period used herein;

(311) stopping displaying the main object A, and then proceeding to an end;

(320) stopping displaying the plurality of secondary objects B, and then proceeding to the step (302).

In the embodiment, the main object A is displayed on the central of the touch screen 11, and the plurality of secondary objects B move toward the peripheral of the touch screen 11 from the main object A and are on the touch screen 11 in an arrangement upon the physical object touching a position on the touch screen 11 corresponding to the main object A. In practice, the embodiment is not a limitation. For other operations, the main object A can be displayed on a position adjacent to the upper left corner of the touch screen 11, and the secondary objects B move downwardly from the main object A and are displayed in an arrangement on the touch screen 11 upon the finger of an operator touching a position on the touch screen corresponding to the main object A. More, the secondary objects B are directly displayed in an arrangement on specific positions of the touch screen 11 but without moving effect. Therefore, for different visual effects, manufacturers may vary the display ways for the secondary objects B. As shown in FIG. 2, while the screen-locking program 21 is executed and the physical object touches the position on the touch screen 11 corresponding to the main object A, the electronic device 1 may further display the secondary objects B on the touch screen 11. Next, if the physical object keeps on touching the position on the touch screen 11 corresponding to the main object A, and the touching time has lasted for a first period as two seconds, the method proceeds to the latter stage. If the physical object leaves the touch screen 11 during the first period, the electronic device 1 may stop displaying the secondary objects B, and upon a physical object again touching the position on the touch screen 11 corresponding to the main object A, the electronic device 1 will again display the secondary objects B on the touch screen 11. In the embodiment, if the position on the touch screen 11 corresponding to the main object A is not touched during a third period, the electronic device 1 may stop displaying the main object A. The embodiment is not a limitation. Manufacturers may vary the settings of the screen-locking program 21 in order to let the button 12 be pressed to display the main object A. Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims. For the embodiment, as shown in FIG. 1, the detecting unit 13 determines whether the physical object leaves the touch screen 11. In practice, a detected object can be described as that of determining whether the physical object leaves the position on the touch screen 11 corresponding to the main object A. That is, manufacturers may vary the settings of the screen-locking program 21. While the physical object moves on the touch screen 11 and leaves the position corresponding to the main object A, the electronic device 1 may stop displaying the secondary object B. Various ways for the physical to leave the touch screen may be implemented.

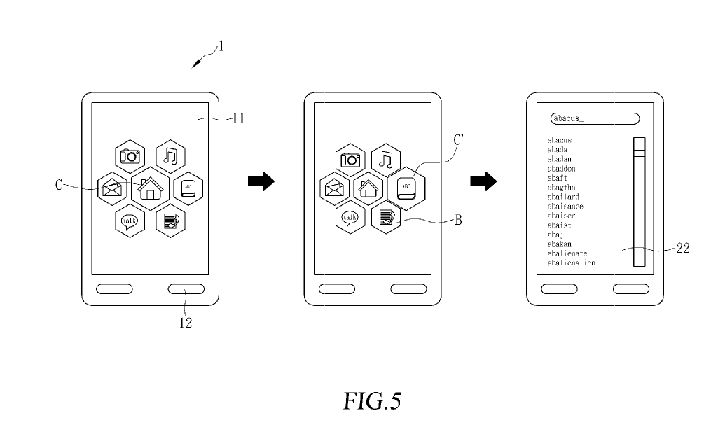

The following is a discussion about the latter stage in the unlocking method according to the invention. With reference to FIG. 3B and FIG. 5, the latter stage in the method in an embodiment includes the steps of:

(305) highlighting the main object A or at least one of the secondary objects as a highlighted object C; it's noted that the highlighting may be performed using such as a cursor, vibration, color-change, or dimensional change on the object to be highlighted.

(306) determining whether the physical object's touching on the main object has lasted for a second period, which is longer than the first period; if yes, proceeding to step (307), otherwise, proceeding to step (330);

(307) de-highlighting the highlighted object C and highlighting the main object or another of the secondary objects as a highlighted object C;

(308) determining whether the physical object leaves the position of the main object when the main object or a secondary object is highlighted; if yes, proceeding to step (330), otherwise, proceeding to step (306);

(330) deactivating the screen-locking program 21 (meaning unlocking the screen), and then proceeding to step (331);

(331) determining whether a secondary object is highlighted when the physical object leaves the position of the main object; if yes, proceeding to step (332), otherwise, proceeding to an end;

(332) activating an application 22 that corresponds to the secondary object B highlighted when the physical object leaves the position of the main object, and then proceeding to an end. In some embodiments, the step of activating the application 22 may be performed substantially simultaneously with the step (330) of deactivating the screen-locking program 21.

In an embodiment, the main object A is enlarged while displayed on the touch screen 11 as a highlighted object C as opposed to other secondary objects B. In addition, a pattern for the main object A is changed from a key to a house for reminding that the operator is under the latter stage in the method. In practice, above embodiment is not a limitation. Manufacturer is also able to design the pattern to be a fixed pattern, so that only the dimensions of the fixed pattern is changed upon the main object A being a highlighted object C. Further, in other implementations, the main object A can become the highlighted object C through other highlighting ways, such as cursor, vibration, color-change, etc. The highlighting effect is achieved as long as the highlighted object is distinguishable to the operator from the other objects not highlighted.

Additionally, in another embodiment, upon the main object A being the highlighted object C, and the physical object leaves the touch screen 11 during a second period such as one second, the electrical device 1 may directly deactivate the screen-locking program and go back to presenting a screen prior to the unlocking method being executed. However the invention is not limited to this way of presenting a prior screen in this embodiment. Manufacturers may change the settings of the screen-locking program 21, and therefore, when the electronic device 1 deactivates the screen-locking program 21, one manual screen, such as generally called desktop, of the electronic device 1 is displayed on the touch screen 11 for the operator to execute operations and select functions through the touch screen 11. After the main object A becomes the highlighted object C, and the physical object keeps on touching the position on the touch screen 11 corresponding to the main object A, and the touching has lasted for the second period, the electronic device 1 may de-highlight the highlighted object C, and one of the secondary objects B is then highlighted on the touch screen 11 as another highlighted object C′.

With reference to FIG. 3B and FIG. 5, after the secondary object B becomes the highlighted object C′, and the physical object leaves the touch screen 11 in the second period, the electronic device 1 may deactivate the screen-locking program 21 and simultaneously execute an application 22 corresponding to the secondary object B. For the present embodiment, the secondary object B corresponds to a digital E-C dictionary.

Upon the secondary object B being the highlighted object C′, and the physical object leaves the touch screen 11 in the second period, the electronic device 1 deactivates the screen-locking program 21 and executes the digital E-C dictionary simultaneously. Hence, once the operator deactivates the screen-locking program 21, the E-C dictionary can be used right away without using other operations. It is highly increasing convenience. After the secondary object B becomes the highlighted object C′, and the physical object keeps on touching the position on the touch screen 11 corresponding to the main object A, and the touching has lasted for the second period, the electronic device 1 may de-highlight the highlighted object C′, one of the other secondary objects B may be highlighted on the touch screen 11. Thus, the secondary object B is another highlighted object C′.

Further, the second period is measured from the time of any of the secondary objects B being the highlighted object C′ to the time of the secondary object B being de-highlighted and another secondary object B being another highlighted object C′. If the physical object keeps on touching the position on the touch screen 11 corresponding to the main object A, and every second period is passed, the mark of highlighting a secondary object B will be moving to another secondary object B in order, thus every secondary object B may be a highlighted object C′ sequentially. For the embodiment, the mark clockwise moves from the secondary object B of the right-hand side of the main object A to the secondary object B at the top right of the main object A, and when the second period is reached, the electronic device 1 may de-highlight the highlighted object C′, and the main object A is again a highlighted object C′, hence it is a loop. The present embodiment is not a limitation. The mark should not only move between two neighbor secondary objects B. The operator may set up the order of the movement of the mark through the setting program 23, as shown in FIG. 2, or set up the setting program 23 to adjust the order of the movement of the mark based on the frequency status of the operator executing the applications 22, so that the mark is able to move among the secondary objects B. Besides, the main object A may not only be the first highlighted object C in the loop, and the order of the mark moving to the main object A can be from the last or middle of the loop. For instance, in another embodiment, since an operator always activates an e-mail program upon unlocking, the setting program 23, as shown in FIG. 2, adjusts the order of the movement of the mark depending on the calculation result received by the statistical program 231, as shown in FIG. 2. Accordingly, while the physical object keeps on touching the position on the touch screen 11 corresponding to the main object A, and the touching has lasted for the first period, the method proceeds to the latter stage, the electronic device 1 may highlight a secondary object B corresponding to the e-mail program on the touch screen 11, thus the secondary object B is a highlighted object C′. The electronic device 1 may rapidly deactivate the screen-locking program 21 and activate the e-mail program upon the physical object leaving the touch screen 11. The present embodiment is not a limitation. Operator may adjust the order of the arrangement of the secondary objects or the order of the movement of the mark by himself.

With reference to FIG. 1 and FIG. 2 again, through the method for unlocking a touch screen provided by the present invention, operator uses a physical object to touch a position on the touch screen 11 corresponding to the main object A so as to easily operate the method for unlocking touch screen, and only changing the touching time of the physical object touching the touch screen 11 is to activate different applications without memorizing different activation ways for different applications 22. That is, the convenience is highly promoted. Additionally, since everyone is independent to define the order of the arrangement of the secondary objects B or the order of the movement of the mark and adjust the screen-locking program 21 based on demands, the flexibility of the electrical device 1 is highly raised to satisfy different customers.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for unlocking a touch screen, applicable to an electronic device that has a touch screen, the method comprising the steps of:
displaying a main object on the touch screen, upon the touch screen being locked;
displaying a plurality of secondary objects in an arrangement on the touch screen upon a physical object touching a position on the touch screen corresponding to the main object;
highlighting the main object or at least one of the secondary objects on the touch screen when the physical object's touch on the position has lasted for a first period;
de-highlighting the main object or said at least one of the secondary objects on the touch screen and highlighting the main object or another of the secondary objects on the touch screen, when the physical object's touch on the position has lasted for a second period, wherein the second period is longer than the first period; and
upon the physical object leaving the position on the touch screen when a secondary object of the secondary objects is highlighted, unlocking the touch screen and activating an application corresponding to the secondary object.

2. The unlocking method according to claim 1 further comprising a step of the electronic device performing a configuring program to determine the arrangement of the secondary objects on the touch screen.

3. The unlocking method according to claim 2 further comprising a step of the electronic device performing the configuring program to determine the arrangement of the secondary objects on the touch screen, according to the number of times the application has been activated.

4. The unlocking method according to claim 1 further comprising a step of the electronic device performing a configuring program to determine a sequence in which the secondary objects are highlighted on the touch screen.

5. The unlocking method according to claim 4 further comprising a step of the electronic device performing the configuring program to determine the sequence in which the secondary objects are highlighted on the touch screen, according to the number of times the application has been activated.

6. The unlocking method according to claim 1 further comprising a step of the electronic device performing a calculating program to calculate the number of times the application has been activated.

7. The unlocking method according to claim 1 further comprising a step of the electronic device performing a calculating program to calculate the number of times the application has been activated upon the touch screen being unlocked.

8. The unlocking method according to claim 1 further comprising a step of upon the physical object leaving the position on the touch screen when the main object is highlighted, unlocking the touch screen.

9. The unlocking method according to claim 1 further comprising a step of upon the physical object leaving the position on the touch screen when the main object is highlighted, unlocking the touch screen and displaying a function menu of the electronic device on the touch screen.

10. The unlocking method according to claim 1, wherein in the step of displaying a plurality of secondary objects in an arrangement, the secondary objects move away from the position of the main object in order to form the arrangement on the touch screen.

11. A method for unlocking a touch screen, applicable to an electronic device that has a touch screen, the method comprising the steps of:
displaying a main object on the touch screen, upon the touch screen being locked;
displaying a plurality of secondary objects in an arrangement on the touch screen upon a physical object touching a position on the touch screen corresponding to the main object;
highlighting the main object or at least one of the secondary objects on the touch screen when the physical object's touch on the position has lasted for a first period;
de-highlighting the main object or said at least one of the secondary objects on the touch screen and highlighting the main object or another of the secondary objects on the touch screen, when the physical object's touch on the position has lasted for a second period, wherein the second period is longer than the first period; and
upon the physical object leaving the position on the touch screen-when the main object or a secondary object of the secondary objects is highlighted, unlocking the touch screen.
